(19) United States
(12) Patent Application Publication
(10) Pub. No.: US 2015/0223413 A1
(43) Pub. Date: Aug. 13, 2015

(54) COLLAPSIBLE GARDEN TRELLIS ASSEMBLY

(71) Applicant: Peter Lalicata, Mequon, WI (US)

(72) Inventor: Peter Lalicata, Mequon, WI (US)

(21) Appl. No.: 14/177,429

(22) Filed: Feb. 11, 2014

(51) Int. Cl. A01G 17/06

(52) U.S. Cl. CPC A01G 17/06

(57) ABSTRACT

A system and method of forming a garden trellis assembly that includes a plurality of generally planar panels that are pivotably connected to one another such that the assembly can attain a stowed orientation, wherein the panels are generally parallel to one another, and a deployed orientation, wherein the panels are oriented in a generally vertical triangular orientation along the length of the panels.

### BACKGROUND OF THE INVENTION

The present invention relates generally to a garden trellises, and more specifically, to a garden trellis assembly that includes a plurality of panels that pivotably cooperate with one another such that the trellis assembly can attain a deployed orientation wherein vegetation can be supported by each respective panel and a stowed orientation wherein the plurality of panels can be positioned generally parallel to one another.

Garden trellises are commonly understood as providing support for elevated portions of vegetation. Such support may be considered beneficial for those applications were limited garden spaces available, accommodating a climbing nature of the desired vegetation, and/or for flower, fruit, or vegetable producing vegetation where it is desirable to maintain isolation of the flower, fruit, vegetable, or other produce from contact with the underlying soil to maintain the integrity of the produce. Although some climates accommodate year-round production of such vegetation, and thereby year-round utilization of the respective trellises, other climates and growing procedures can necessitate periodic removal and/or storage of any given trellis system. Amending, aerating, and/or tilling of the soils associated with many produce generating plants can also periodically require movement and/or removal of the respective trellis assembly from a desired location. Many attempts have been made to improve the utility of garden trellis assemblies but many suffer from various drawbacks.

One commonly utilized garden trellis assembly is defined by a generally frustoconical shaped wire form trellis. The smaller diameter end of the wire form generally includes a number of free wire ends that are intended to be pressed into the ground such that a respective plant is can positioned within the confines of the wire form. As the plant grows, a main stem commonly progresses substantially upward within the confines of the frustoconical wire form with various branches or stems extending in outward radial directions there beyond. Utilization of such trellises with heavier fruits and/or vegetables, such as tomatoes, can result in non-uniform loading of the wire form. If left unaddressed, such non-uniform loading can ultimately result in failure of the trellis in any radial direction associated with a higher yield of a given plant. Once deformed, such trellises must commonly be manually reshaped prior to subsequent use. Such trellises also commonly require complete destruction of the vegetation to effectuate removal of the trellis from the gardening site.

For storage, such trellises are commonly loosely nested relative to one another provided the shape of each respective trellis has not been excessively altered during installation, interaction with the respective plant during the growing season, and/or removal of each respective trellis from the gardening site. At this those skilled in the art will readily appreciate, one growing season is commonly sufficient to alter the shape of each respective trellis such that nesting a number of the wire form trellises relative to one another can be a labor intensive and commonly frustrating endeavor. The terminal wire ends associated with supporting the trellis in a planting bend commonly interfere with other wire form trellises during the nesting process further frustrating the ability of the user to associate multiple trellises in a compact arrangement. Even once nested, such trellises are commonly top heavy, awkward to handle, and maintain a generally cylindrical shape such that storage of the multiple nested trellises requires more space than associated with the cylindrical shape associated with the volume occupied by the wire form.

Others having recognized the shortcomings of such trellis assemblies have attempted to improve the functionality associated with the sane but only with limited degrees of success. One such system maintains the generally frustoconical shape of the wire form but defines the trellis assembly with multiple curved portions that removably cooperate with one another. Such assemblies only complicate the shortcomings discussed above as deviation of discrete portions of the wire forms from an original shape can complicate subsequent connection of the respective curved portions as well as nesting of the same.

Still others provide more rectilinear trellis assemblies that can include a support which extends in a rearward direction from a growing surface and engages the ground to support to the growing surface associated with elevated propagation of the vegetation. Such systems can detract from efficient utilization of available gardening space by defining only one growing surface associated with utilization of the trellis assembly. In an effort to minimize the detriments of such a consideration, many provide trellis assemblies that are vertically elongated in the hopes that the vegetation will more vertically than horizontally propagate. Such systems have proved to be less than desirable in as much as many varieties of vegetation are unable to attain the vertical propagation afforded such trellis assemblies, generate produce that when sufficiently offset from the ground surface, has mass sufficient to collapse the respective trellis assemblies, and undesirably shade adjacent vegetation for, undesired portions of daylight hours.

Therefore, there is a need for a garden trellis assembly that can be quickly and efficiently deployed and stowed, can attain a compact footprint for storage, and does not unduly interfere with the use or adjacent gardening spaces and/or vegetation.

### BRIEF DESCRIPTION OF THE INVENTION

One aspect of the invention that overcomes one or more of the shortcomings above discloses a garden trellis assembly that includes a plurality of substantially planar panels that are pivotably connected to one another. The plurality of panels are pivotably connected to one another such that the assembly can attain a stowed orientation wherein the panels are generally parallel to one another and a deployed orientation wherein the panels are oriented in a generally vertical triangular orientation along the longitudinal length of the panels. Such a construction allows climbing vegetation to be supported by one side of each respective panel and provides a space between the panels for accommodating more shade tolerant vegetation thereby increasing the yield of garden spaces while maintaining a desired spacing between each respective plant.

Another aspect of the invention that is useable with one or more of the above aspects discloses a garden trellis assembly that includes a first panel and a second panel. Each panel has a substantially planar shape that is defined by opposing longitudinal sides and opposing vertical sides to define a boundary of the respective panel. The respective longitudinal sides are longer than the vertical sides and each panel is preferably formed of an expanded metal material. The assembly includes a first hinge and a second hinge that are each engaged with the first panel and the second panel. The first hinge and the second end are engaged with the first panel and the second panel at locations proximate opposite ends of one of the longitudinal sides such that the first panel and the second panel are pivotably connected to one another to be movable between a collapsed orientation wherein the first panel and the second panel are parallel to one another and a deployed orientation wherein the longitudinal sides opposite the first hinge and the second hinge are spaced from one another and the first panel and the second panel are oriented at inclined orientations to intersect proximate an axis associated with the first hinge and the second hinge. A gauge is pivotably connected to the first panel and constructed to removably cooperate with the second panel to define the deployed orientation of the first panel and the second panel when the gauge is engaged with the second panel.

Another aspect of the invention that is useable with one or more of the above aspects discloses a collapsible garden trellis assembly. The collapsible garden trellis assembly includes a first expanded metal panel and a second expanded metal panel. Each expanded metal panel is defined by a pair of longitudinal sides and a pair of end sides. A first hinge and a second hinge are engaged with each of the first expanded metal panel and the second expanded metal panel such that the first and second expanded metal panels are pivotable relative to one another about an axis defined by the first hinge and the second hinge and such that the axis is aligned with the longitudinal sides of the first and second expanded metal panels. The assembly includes a catch having a first end that is pivotably connected to the first expanded metal panel and a second end that removably cooperates with the second expanded metal panel such that the catch defines a distance between the longitudinal sides of the first and second expanded metal panels that are opposite the first and second hinges when the catch is engaged with the second expanded metal panel and the first expanded metal panel and such that the first and second expanded metal panels can be positioned parallel to one another when the catch is disengaged from the second expanded metal panel.

Another aspect of the invention that is useable with one or more of the above features or aspects discloses a method of forming a garden trellis system. The method includes connecting a first expanded metal panel to a second expanded metal panel such that the first expanded metal panel and second expanded metal panel are rotatable relative to one another about an axis that is adjacent to, and aligned with, a longitudinal edge of the first and second panels. A spacer is connected to the first expanded metal panel so that the spacer is pivotable relative to the first expanded metal panel and a second end of the spacer removably cooperates with the second expanded metal panel such that the first expanded metal panel and second expanded metal panel are movable between a storage orientation wherein the first and second expanded metal panels generally overlie one another and a deployed orientation wherein the first and second expanded metal panels are oriented in an inverted V-shape when the spacer is engaged with the second expanded metal panel and the axis is horizontally oriented and offset from the ground in a geometrical plane that is generally centrally disposed between the first expanded metal panel and the second expanded metal panel.

These and various other aspects, features, and advantages of the present invention will be made apparent from the following detailed description and the drawings.

### BRIEF DESCRIPTION OF THE DRAWINGS

The drawings illustrate one preferred embodiment presently contemplated for carrying out the invention. In the drawings:

FIG. 1 is perspective view of a garden trellis assembly in a deployed or in-use orientation;

FIG. 2 is a view similar to FIG. 1 of the garden trellis assembly shown in FIG. 1 with an optional third and fourth panel associated therewith;

FIG. 3 is an end elevated partial perspective view of the garden trellis assembly shown in FIG. 2;

FIG. 4 is a plan view of a hinge of the garden trellis assembly shown in FIG. 2;

FIG. 5 is a cross-section view of the hinge shown in FIG. 4;

FIG. 6 is a perspective view of the garden trellis assembly shown in FIG. 2 in a fully or partially stowed orientation; and

FIG. 7 is a view similar to FIG. 6 with the garden trellis assembly converted to a stowed orientation wherein the assembly occupies a space generally the same as a multiple of the total number of panels associated with the assembly.

### DETAILED DESCRIPTION OF THE PREFERRED EMBODIMENT

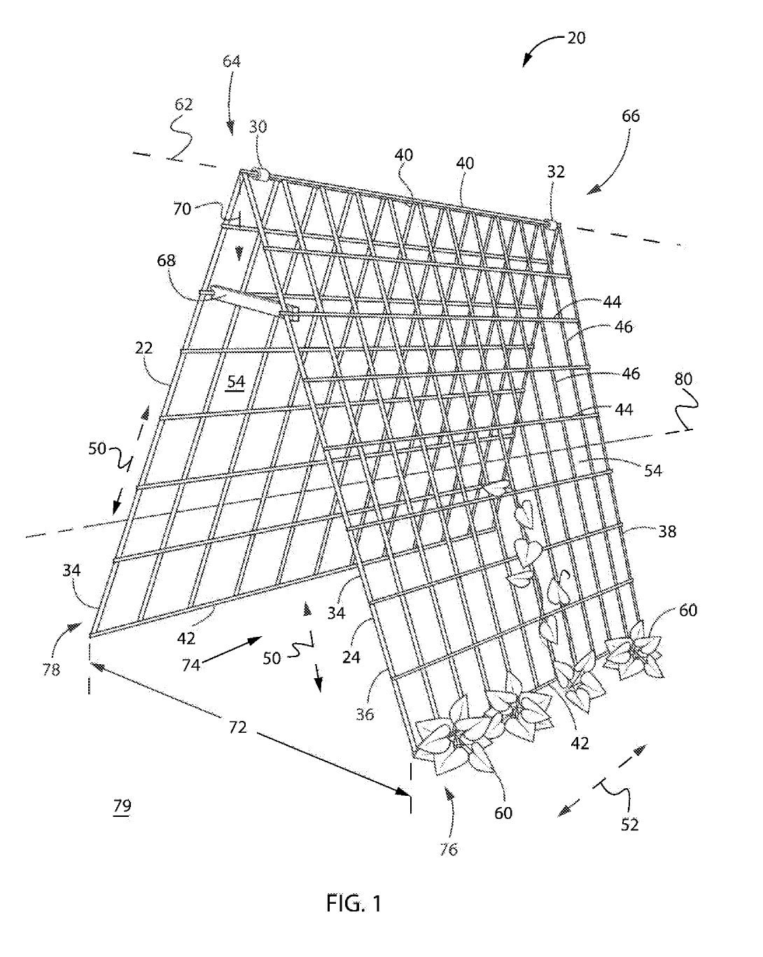

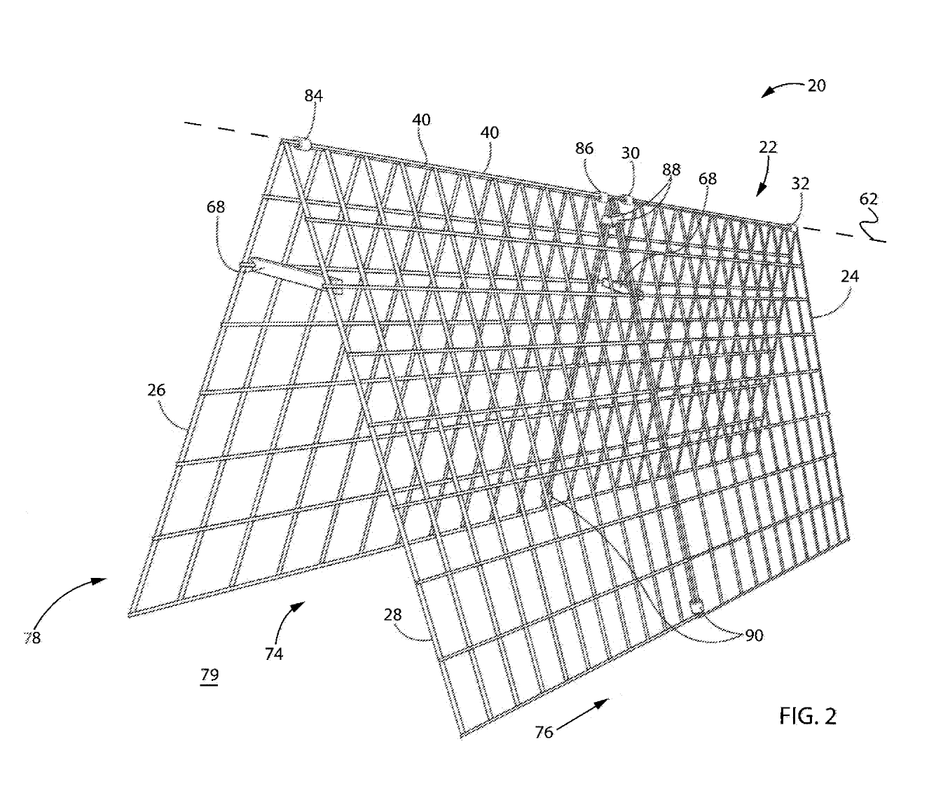

FIG. 1 shows a collapsible garden trellis system or assembly 20 according to the present invention. Garden trellis assembly 20 includes a first panel 22 and a second panel 24 that are pivotably connected to one another so as to be movable relative to one another between a deployed orientation, as shown in FIG. 1, and a stowed orientation as disclosed further below. When in the stowed orientation, garden trellis assembly 20 achieves a generally planar vertical footprint having a width that approximates the total or sum of the widths associated with each discrete panel associated with the assembly. Referring briefly to FIG. 2, garden trellis assembly 20 can include an optional third panel 26 and an optional fourth panel 28 that are also pivotable relative to one another and also pivotable relative to first panel 22 and second panel 24 to accommodate the deployed and stowed configurations of assembly 20 whether provided in a two panel configuration, as shown in FIG. 1, a four panel configuration, as shown in FIG. 2, or configurations having other numbers of panels as described further below.

It is appreciated that assembly 20 can be provided in configurations having numbers of panels other than those shown in FIGS. 1 and 2. For instance, it is appreciated that, for those applications wherein assembly 20 is intended to be positionally associated with more rigid structures, such as buildings or the like, assemblies having an odd total number of discrete panels 22, 24, 26, 28 may prove more suitable for those applications where such positioning would prevent or limit the ability to achieve unfolded configurations of the assembly 20 as shown in FIGS. 1 and 2. It is further appreciated that there may be occasions wherein use of assembly 20 is accommodated by leaning of the device against other rigid structures. Preferably, assembly 20 is configured to be deployed in a self-supported orientation such that vegetation can be associated with multiple external longitudinal sides of the deployed assembly as well as an inward oriented space defined by assembly 20.

As disclosed further below, assembly 20 preferably includes a plurality of discrete panels that are pivotably connected to one another and movable between stowed and in-use orientations. As used herein, the storage or stowed orientation of assembly 20 is generally defined by a compact footprint of the assembly wherein the plurality of panels closely overlie one another such that the overall length and height of the collapsed assembly approximates the overall length and height associated with one panel and the width of the collapsed assembly approximates the sum of the widths of the number of panels associated with the respective assembly. The in-use or deployed orientation of assembly 20 is associated with use of the assembly in a gardening or growing environment associated with vertical support of vegetation along at least one and preferably more than one, of the longitudinal sides of assembly 20 and wherein the discrete panels 22, 24, 26, 28 are oriented in an inverted V-shape configuration relative to one another along the longitudinal length of the assembly.

Referring back to FIG. 1, first panel 22 and second panel 24 are preferably constructed of a rigid mesh material, such as an expanded metal material, and pivotably connected to one another via a first pivot or hinge 30 and a second pivot or hinge 32. Each panel 22, 24, is defined by a perimeter or boundary edge 34 that extends about the respective panel 22, 24. Each boundary edge 34 is defined by opposite lateral ends, sides, or edges 36, 38 that are separated from one another by respective upper longitudinal, ends, sides or edges 40 and lower longitudinal, ends, sides or edges 42 of each respective panel 22, 24. Each panel 22, 24 includes a number of horizontal members 44 and a number of vertical members 46 that extend in respective lateral directions, indicated by arrow 50, and longitudinal directions, indicated by arrow 52.

Adjacent horizontal members 44 and vertical members 46 define a number of spaces, cells, or cavities 54 located within the footprint defined by boundary edge 34. Preferably, each cavity has a dimension of approximately 3 inches aligned with the longitudinal axis of the respective panel 22, 24 and a vertical dimension of approximately 5 inches aligned with a lateral dimension of each respective panel 22, 24. Such dimensioning has proved to be beneficial to providing the desired support of vegetation 60, and the vegetables or fruit associated therewith, associated with use of garden trellis assembly 20. Even so, it is appreciated that deviations within approximately 2 inches of either of these dimensions may prove suitable for specific applications. Preferably, cavities 54 maintain a vertically oriented dimension that is greater than the longitudinally oriented dimension.

Preferably, each panel 22, 24 has an overall dimension of approximately 45 inches associated with the vertical direction 50 and a dimension of approximately 60 inches or 5 feet with respect to a longitudinal and horizontal direction 52. Testing has shown such a configuration, provides adequate support for climbing vegetation 60, and the produce associated therewith, without unduly loading garden trellis assembly 20 in a manner which could result in inadvertent collapse of the same. It is appreciated that deviations of within six inches of either of these dimensions may prove suitable for certain vegetation specific applications.

Hinges 30, 32 cooperate with the upper longitudinal edge 40 of first and second panel 22, 24 such that first panel 22 and second panel 24 are pivotable relative to one another about an axis 62 generally defined by hinges 30, 32. Hinges 30, 32 are positioned proximate a respective first end 64 and a respective second end 66 of the upper longitudinal edge 40 of panels 22, 24. It is appreciated that other numbers of hinges are envisioned. Regardless of the number of hinges provided, hinges 30, 32 facilitate rotation of panels 22, 24 relative to one another during movement of garden trellis assembly 20 between a stored configuration and an in-use configuration.

A catch or a gauge 6& is pivotably connected to first panel 22 and selectively engageable with second panel 24. Gauge 68 is offset in a downward vertical direction, indicated by line 70, from axis 62. When engaged with second panel 24, gauge 68 defines a distance 72 between lower longitudinal ends 42 of panels 22, 24 when garden trellis assembly 20 is in the deployed orientation as shown in FIG. 1. Preferably, distance 72 is approximately between about 2 feet and about 5 feet when gauge 68 is engaged with second panel 24 and garden trellis assembly 20 is in the deployed position but it is appreciated other values of distance 72 can be provided due to changes associated with the height of the discrete panels. In a preferred embodiment, the value associated with distance 72 is less than, equal too, or only slightly greater than the value associated with the height of one of panels 22, 24. It is further appreciated that garden trellis assembly 20 can be provided with one or other numbers of gauges 68 and that such gauges 68 can be positioned at different locations along the longitudinal and vertical lengths associated with panels 22, 24. Understandably, the lengths of gauges 68 will vary as the gauges are disposed nearer one of upper longitudinal edge 40 or lower longitudinal ends 42 of panels 22, 24 of garden trellis assembly 20.

When deployed, first panel 22 and second panel 24 define a first vegetation site 74 generally between lower longitudinal ends 42 of first panel 22 and second panel 24 and second and third vegetation sites 76, 78 that are oriented generally laterally outward relative to a respective panel 22, 24. It is appreciated that vegetation site 74 is suitable for the development and growth of more shade tolerant and generally non-climbing vegetation whereas vegetation sites 76, 78 are more suitable for the development and growth of vining or climbing vegetation 60 in a manner wherein the vegetation and the produce associated therewith is supported via the vegetations association with the laterally outward facing sides of the respective panels 22, 24.

As shown in FIG. 1, garden trellis assembly 20 attains an inverted V-shaped orientation relative to axis 62 and a planting or ground surface 79 associated with supporting growth of vegetation 60. When supported by even ground, axis 62 is preferably contained within a vertical plane that contains axis 62, line 70 and a longitudinal centerline 80 associated with panels 22, 24 of garden trellis assembly 20. Positioning vegetation in rows at plant sites 76, 78 provides for generally uniform lateral loading of garden trellis assembly 20 such that the shape of the garden trellis assembly 20 and the vegetation associated with the opposite lateral sides thereof assists with the vertically oriented support thereof. Said another way, the cooperation and orientation of panels 22, 24 and the orientation of vegetation 60 associated therewith, reduces the potential for the collapse of garden trellis assembly 20 due to uneven loading associated with the growth of vegetation proximate thereto. Such a construction also encourages the production of fruits and vegetables toward the laterally oriented external, and thereby more readily accessible, sides of garden trellis assembly 20. Plantings associated with vegetation site 74 can be conveniently accessed from the alternate longitudinal ends of assembly 20 defined by the cooperation of first panel 22 and second panel 24.

FIG. 2 shows a configuration of garden trellis assembly 20 equipped with optional third panel 26 and fourth panel 28. The construction and cooperation of third panel 26 and forth panel 28 with respect to each other is the same as that described above with respect to the construction and cooperation of first panel 22 and second panel 24. Third panel 26 and fourth panel 28 are pivotably connected to one another via one or more pivots or hinges 84, 86 associated with the upper longitudinal edges 40 thereof such that first, second, third, and fourth panels 22, 24, 26, 28 are pivotable about axis 62. Optional third and fourth panels 26, 28 can also include a catch or gauge 68 associated therewith. Preferably, gauge 68 has a similar construction, location, and operation as the catch 68 associated with first and second panels 22, 24. Such a construction facilitates the user's expedient understanding and manipulation of garden trellis assembly 20 when manipulating the garden trellis assembly between the stowed and deployed orientations as disclosed further below.

Adjacent lateral ends of first panel 22 and third panel 26 and second panel 24 and fourth panel 28 are pivotably connected to one another via a first or upper pivot or hinge 88 and a second or lower pivot or hinge 90. Hinges 88, 90 accommodate rotation of first and second panel 22, 24 relative to third and fourth panel 26, 28 about an axis that is oriented in a crossing direction or transverse to axis 62 and facilitate conversion of the garden trellis assembly between the deployed orientation and a stowed orientation wherein each of the discrete panels 22, 24, 26, 28 can be positioned in an overlying orientation. Such a consideration allows garden trellis assembly 20, regardless of how many panel pairs are associated therewith, to attain a stowed configuration footprint that approximates the length and height associated with a single panel 22, 24, 26, 28 and a width that approximates a sum or a multiple of the width associated a total number of individual panels 22, 24, 26, 28 associated with the respective assembly 20.

As explained further below with respect to FIG. 7, when in the stowed configuration, the multiple panels 22, 24, 26, 28 of garden trellis assembly 20 achieve orientations relative to one another such that an elevational or side footprint associate with assembly 20 is approximately the same as the elevational footprint associated with a single discrete panel. Such operability allows assembly 20 to occupy a reduced amount of space when in the stowed configuration as compared to the deployed orientation. The generally planar stowed configuration also allows for convenient storage of assembly 20 is close proximity along planar structures such as walls or the like. The compact stowed orientation also improves the ability of a single user to transport and deploy assembly 20 and improves the ability to transport garden trellis assembly 20 relative to tight quarters, such as doorways and the like. It should further be appreciated that the cooperation of third panel and fourth panel 26, 28 with first and second panel 22, 24, respectively, effectively doubles the longitudinal length associated with vegetation sites 74, 76, 78.

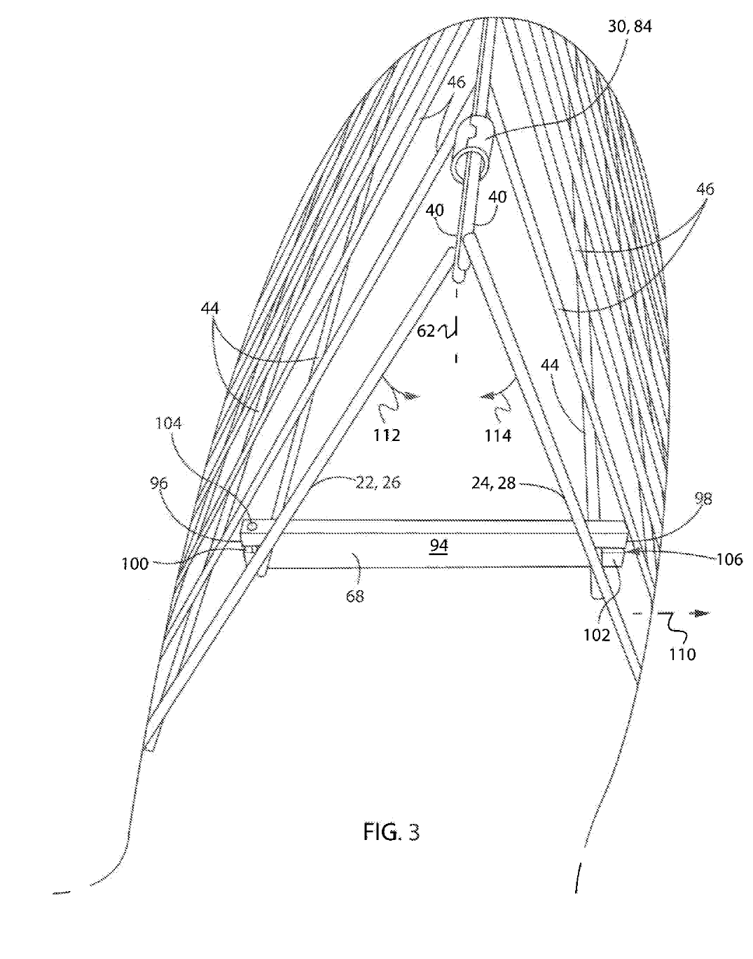

FIG. 3 is a detailed perspective view of gauge 68 associated with first and second panels 22, 24, or optional third and fourth panels 26, 28, and hinge 30, 84 positioned proximate thereto. Gauge 68 is defined by an elongate body 94 that extends between a first end 96 and a second end 98 of each gauge 68. Gauge 68 is preferably formed of a plastic material but it is appreciated that gauge 68 could be constructed of any number of materials. Body 94 includes a first slot or groove 100 formed proximate first end 96 and a second groove or slot 102 that is formed proximate second end 98 of gauge 68. Groove 100 and slot 102 are shaped to movably cooperate with a horizontal member 44 of the respective panel 22, 24, 26, 28.

Gauge 68 includes a pin 104 that traverses groove 100 such that horizontal member 44 can be captured in groove 100 and gauge 68 is rotatable relative thereto. Slot 102 includes an open end 106 that slidably cooperates with horizontal member 44 of second panel 24, 28 when gauge 68 is rotated such that slot 102 is an alignment therewith. It should be appreciated that generally lateral outward deflection, indicated by arrow 110, of panel 24, 28 relative to panel 22, 26 allows horizontal member 44 to disengage from slot 102 such that gauge 68 can be rotated out of alignment or engagement with panel 24, 28 thereby allowing inward radial rotation, indicated by arrows 112, 114 of panel 22, 26 and panel 24, 28 about axis 62 such that the respective panels 22, 24, 26, 28 can generally overlie the laterally adjacent panel when gauge 68 is disengaged from a respective horizontal members 44.

Although shown as engaged with the horizontal members 44 of the respective panel 22, 24, 26, 28, it is further appreciated that gauge 68 could be contoured to cooperate with other members of the respective panels 22, 24, 26, 28, such as vertically oriented members 46, so as to be rotationally engaged with one member and removable engaged with another member of the adjacent panel to define the spatial relationship therebetween. It is further appreciated that gauge 68 could be constructed to removably cooperate with each respective panel although such a construction would be less desirable as possibly resulting requiring replacement of the catch.

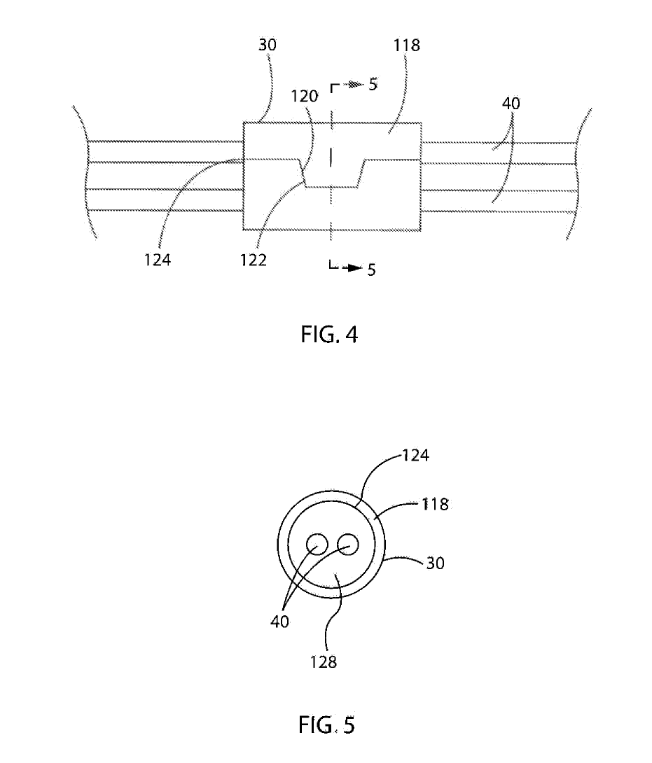

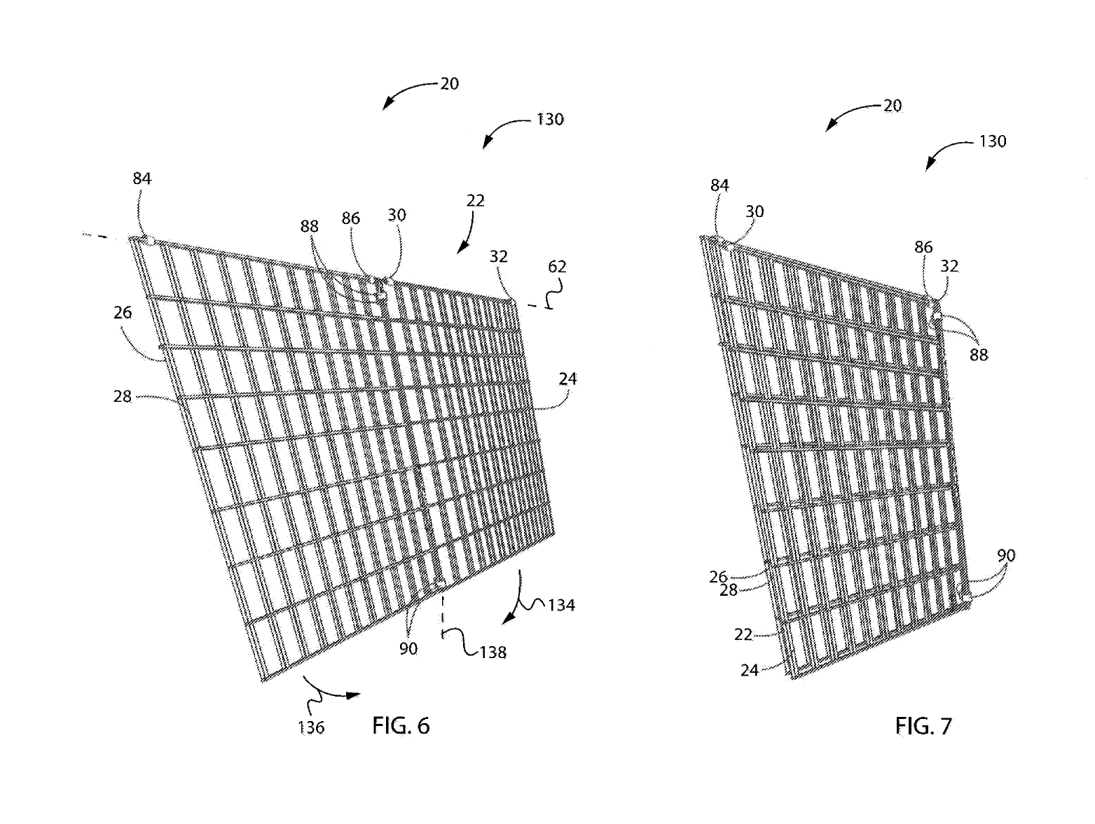

FIGS. 4 and 5 show various views of hinge 30 associated with garden trellis assembly 20. It should be appreciated that, although oriented at different positions, the construction and cooperation of hinges 32, 84, 86, 88, 90 associated with garden trellis assembly 20 is the same as the construction and cooperation of hinge 30 as described further below. Hinge 30 is defined by a body 118 that is preferably formed of a metal material which can be deformed to generally surround respective portions of the expanded metal associated with panels 22, 24, 26, 28, such as upper longitudinal edge 40. Body 118 includes alternate ends 120, 122 that cooperate with one another to define a seam 124 that extends along the longitudinal length of hinge 30. When disposed about portions of the respective panels 22, 24, 26, 28, body 118 extends around upper longitudinal edge 40 of adjacent panels 22, 24, 26, 28 such that body 118 extends about a space 128 sufficient to allow panels 22, 24, 26, 28 to be positioned adjacent one another and/or separated by one or more panels 22, 24, 26, 28 that may be disposed between the respective panels 22, 24, 26, 28 to which the respective hinge is engaged. Such a consideration accommodates “folding” of garden trellis assembly 20 as described further below with respect to FIGS. 6 and 7 to attain the stored configuration alluded to above.

As shown in FIGS. 6 and 7, after a growing season, garden trellis assembly 20 can achieve a stowed configuration or orientation 130 wherein first panel 22 and second panel 24 are oriented generally parallel to one another and in an overlying relationship via the rotation of panels 22, 24 about axis 62 defined by hinges 30, 32 when gauge 68 is disengaged from the respective panel 22, 24 with which it removably cooperates. When equipped with optional third and fourth panels 26, 28, disengagement of additional catches or gauges 68 from the panels with which they removably cooperate allow similar rotation of the optional third and fourth panels 26, 28 about axis 62 relative to one another.

When provided in the extended configuration that includes optional third and fourth panels 26, 28, first and second panel pair 22, 24 and optional third and fourth panel pair 26, 28 are rotatable relative to one another in generally lateral directions, indicated by arrows 134, 136, about a generally vertical axis, indicated by line 138, associated with hinges 88, 90. Such rotation allows panels 22, 24, 26, 28 to achieve a generally planar stacked orientation wherein each of panels 22, 24, 26, 28 generally overlie one another such that a spatial footprint associated with garden trellis assembly 20, when equipped with optional panels 26, 28, when in the stowed orientation 130, occupies a space that is generally defined by the elevational footprint of each respective panel and the width that approximates the sum of the widths of the discrete panels. Such a construction provides a multi-panel garden trellis assembly 20 that can be quickly and conveniently stored and deployed.

When provided with optional third and fourth panels 26, 28, hinges 88, 90 are preferably sized to accommodate the generally laterally outward orientation of respective panels previously associated with a common longitudinal side of assembly 20. Alternatively, it is appreciated that assembly 20 may be provided with only one set of vertically oriented hinges 88, 90 such that the alternate panels associated with the assembly can be provided with severable hinge connections or simply a severable connection such that one pair of the adjacent common longitudinal side panels cooperate with one another along a separable joint thereby mitigating the need to accommodate the space associated with allowing the adjacent common longitudinal side panels to be disposed on opposite sides of two panel previously associated with another common longitudinal side of assembly 20 when provided in a more than two total panel configuration.

Although shown as including only one set of optional panels 26, 28, it is further appreciated that panels 22, 24 could have optional panels 26, 28 associated with the opposite longitudinal ends thereof. It is further appreciated that when provided in such a configuration, the panels associated the longitudinally outward panel pairs would be foldable relative to the centrally disposed panel pair in opposite rotational directions 134, 136 relative to the centrally oriented panels 22, 24. Said in another way; the opposite panel pairs would fold toward opposite lateral sides of the centrally oriented panel pair thereby expanding garden trellis assembly 20 by another multiple of the space associated with optional panels 26, 28 and in a manner that still accommodated a folded vertical footprint of the assembly that approximates the dimension of a single panel even though the stored width would increase by amount of the width associated with two panels.

Garden trellis assembly 20 provides a collapsible vegetation trellis that can be quickly and conveniently converted between storage and in-use configurations in a manner that provides a compact readily manageable and stowable stored configuration of the garden trellis assembly. The multiple vegetation sites accommodate use of garden trellis assembly 20 for propagation of climbing as well as more shade tolerant vegetation thereby improving the efficiency with which, growers may utilize available gardening space.

Therefore, one embodiment of the invention includes a garden trellis assembly having a first panel and a second panel. Each panel has a substantially planar shape and is defined by opposing longitudinal sides and opposing vertical sides that define a boundary of the respective panel. The respective longitudinal sides are longer than the vertical sides and each of the first panel and the second panel is formed of an expanded metal material. The assembly includes a first hinge and a second hinge that are each engaged with the first panel and the second panel. The first hinge and the second hinge are engaged with the first panel and the second panel at locations proximate opposite ends of one of the longitudinal sides such that the first panel and the second panel are pivotably connected to one another to be movable between a collapsed orientation wherein the first panel and the second panel are parallel to one another and a deployed orientation wherein the longitudinal sides opposite the first hinge and the second hinge are spaced from one another and the first panel and the second panel are oriented at inclined orientations to intersect proximate an axis associated with the first hinge and the second hinge. A gauge is pivotably connected to the first panel and constructed to removably cooperate with the second panel to define the deployed orientation of the first panel and the second panel when the gauge is engaged with the second panel.

Another embodiment of the invention that is useable with one or more of the features or above embodiments includes a collapsible garden trellis assembly having a first expanded metal panel and a second expanded metal panel. Each expanded metal panel is defined by a pair of longitudinal sides and a pair of end sides. A first hinge and a second hinge are engaged with each of the first expanded metal panel and the second expanded metal panel such that the first and second expanded metal panels are pivotable relative to one another about an axis defined by the first hinge and the second hinge and wherein the axis is aligned with the longitudinal sides of the first and second expanded metal panels. The assembly includes a catch having a first end that is, pivotably connected to the first expanded metal panel and a second end that removably cooperates with the second expanded metal panel such that the catch defines a distance between the longitudinal sides of the first and second expanded metal panels that are opposite the first and second hinges when the catch is engaged with the second expanded metal panel and such that the first expanded metal panel and the second expanded metal panel can be positioned parallel to one another when the catch is disengaged from the second expanded metal panel.

Another embodiment of the invention that is useable or combinable with one or more of the features or embodiments above includes a method of forming a garden trellis system. The method includes connecting a first expanded metal panel to a second expanded metal panel such that the first expanded metal panel and second expanded metal panel are rotatable relative to one another about an axis that is adjacent to, and aligned with, a longitudinal edge of the first and second panels. A spacer is connected to the first expanded metal panel so that the spacer is pivotable relative to the first expanded metal panel and the spacer removably cooperates with, the second expanded metal panel. The first expanded metal panel and second expanded metal panel are movable between a storage orientation wherein the first and second expanded metal panels generally overlie one another and a deployed orientation wherein the first and second expanded metal panels are oriented in an inverted V-shape when the spacer is engaged with the second expanded metal panel and the axis is horizontally oriented and offset from the ground in a geometrical plane that is disposed between the first expanded metal panel and the second expanded metal panel.

The present invention has been described in terms of the preferred embodiment, and it is recognized that equivalents, alternatives, and modifications, aside from those expressly stated, are possible and within the scope of the appending claims.

What is claimed is:

1. A garden trellis assembly comprising;
a first panel and a second panel, each panel having a substantially planar shape and being defined by opposing longitudinal sides and opposing vertical sides that define a boundary of the respective one of the first panel and the second panel, wherein the respective longitudinal sides are longer than the vertical sides and each of the first panel and the second panel are formed of an expanded metal material;
a first hinge engaged with the first panel and the second panel;
a second hinge engaged with the first panel and the second panel, the first hinge and the second hinge being engaged with the first panel and the second panel at locations proximate opposite ends of one of the longitudinal sides such that the first panel and the second panel are pivotably connected to one another to be movable between a collapsed orientation wherein the first panel and the second panel are parallel to one another and a deployed orientation wherein the longitudinal sides opposite the first hinge and the second hinge are spaced from one another and the first panel and the second panel are oriented at inclined orientations to intersect proximate an axis associated with the first hinge and the second hinge; and
a gauge pivotably connected to the first panel and constructed to removably cooperate with the second panel to define the deployed orientation of the first panel and the second panel when the gauge is engaged with the second panel.

2. The garden trellis assembly of claim 1 further comprising a third panel and a fourth panel that are each formed of an expanded metal and have the same shape as a respective one of the first panel and the second panel, the third panel being pivotably connected to the fourth panel by at least one hinge engaged with aligned longitudinal sides of the third panel and the fourth panel.

3. The garden trellis assembly of claim 2 wherein the third panel is pivotably connected to one of the vertical sides of the first panel and the fourth panel is pivotably connected to one of the vertical sides of the second panel.

4. The garden trellis assembly of claim 3 wherein the third and fourth panels are movable between a collapsed orientation wherein the fourth panel is adjacent the second panel and between the second panel and the third panel.

5. The garden trellis assembly of claim 1 wherein the expanded metal material defines a number of rectangular openings that are approximately 3 inches by 5 inches and each of the first panel and the second panel is 45 inches high by 5 feet long.

6. The garden trellis assembly of claim 1 wherein the gauge is formed of a plastic material.

7. The garden trellis assembly of claim 1 wherein the gauge is nearer the longitudinal side of the first and second panels associated with the first hinge and the second hinge than the other longitudinal side of the respective first or second panels.

8. The garden trellis assembly of claim 7 further comprising another gauge pivotably connected to one of the first panel and the second panel and removably engageable with the other of the first and the second panel, the gauges have a similar construction and being disposed near opposite ends of the same longitudinal side.

9. A collapsible garden trellis assembly comprising:
a first expanded metal panel and a second expanded metal panel, each expanded metal panel being defined by a pair of longitudinal sides and a pair of end sides;
a first hinge and a second hinge engaged with each of the first expanded metal panel and the second expanded metal panel such that the first and second expanded metal panels are pivotable relative to one another about an axis defined by the first hinge and the second hinge and wherein the axis is aligned with the longitudinal sides of the first and second expanded metal panels; and
a catch having a first end pivotably connected to the first expanded metal panel and a second end that removably cooperates with the second expanded metal panel such that the catch defines a distance between the longitudinal sides of the first and second expanded metal panels that are opposite the first and second hinges when the catch is engaged with the second expanded metal panel and the first expanded metal panel and the second expanded metal panel can be positioned parallel to one another when the catch is disengaged from the second expanded metal panel.

10. The collapsible garden trellis assembly of claim 9 further comprising a third and a fourth expanded metal panel that are each defined by a pair of longitudinal sides and a pair of end sides that the same respective dimension as one of the longitudinal sides and end sides of first expanded metal panel and the second expanded metal panel.

11. The collapsible garden trellis assembly of claim 10 further comprising a third hinge connecting the first expanded metal panel to the third expanded metal panel and a fourth hinge connecting the second expanded metal panel and the fourth expanded metal panel, the third hinge and the fourth hinge being associated with respective facing end sides of the respective panels.

12. The collapsible garden trellis assembly of claim 11 further comprising another catch pivotably connected to the third expanded metal panel and removably engageable with the fourth expanded metal panel.

13. The collapsible garden trellis assembly of claim 11 further comprising a fifth hinge and a sixth hinge engaged with a respective longitudinal side of the third and fourth expanded metal panels such that the fifth and sixth hinges define an axis of rotation that is coaxial with the axis defined by the first hinge and the second hinge.

14. The collapsible garden trellis assembly of claim 10 wherein each expanded metal panel is defined a plurality of cells that have a length of 3 inches and a height of 5 inches.

15. The collapsible garden trellis assembly of 10 wherein the first, second, third, and fourth expanded metal panels are collapsible to a folded position defined by a space that approximates a length and a height of a single expanded metal panel and a width that is approximately a sum of the widths of the first, second, third, and fourth expanded metal panels.

16. A method of forming a garden trellis system, the method comprising:
connecting a first expanded metal panel to a second expanded metal panel such that the first expanded metal panel and second expanded metal panel are rotatable relative to one another about an axis that is adjacent to and aligned with a longitudinal edge of the first and second panels; and
connecting a spacer to the first expanded metal panel so that the spacer is pivotable relative to the first expanded metal panel and the spacer removably cooperates with the second expanded metal panel such that the first expanded metal panel and second expanded metal panel are movable between a storage orientation wherein the first and second expanded metal panels generally overlie one another and a deployed orientation wherein the first and second expanded metal panels are oriented in an inverted V-shape when the spacer is engaged with the second expanded metal panel and the axis is horizontally oriented and offset from the ground in a geometrical plane that is generally centrally disposed between the first expanded metal panel and the second expanded metal panel.

17. The method of claim 16 further comprising connecting a third expanded metal panel and a fourth expanded metal panel to the first and second expanded metal panel such that the third and fourth expanded metal panels are pivotable relative to one another and pivotable about a generally vertical axis relative to the first and second expanded metal panels.

18. The method of claim 17 further comprising connecting another spacer to one of the third and fourth expanded metal panels at a location opposite the generally vertical axis.

19. The method of claim 16 further comprising planting trellis supported vegetation along outboard longitudinal edges of the first and second expanded metal panels and shade tolerate vegetation inboard if ground supported longitudinal edges of the first and second expanded metal panels.

20. The method of claim 16 further comprising attaching a retainer to one of the first and second expanded metal panels for maintaining the first and second expanded metal panels in the storage orientation.
